(19) United States
(12) Patent Application Publication
(10) Pub. No.: US 2016/0289931 A1
(43) Pub. Date: Oct. 6, 2016

(54) FINE CERAMIC VALVE FOR FAUCETS

(71) Applicant: Chia-Po Chang, Changhua (TW)

(72) Inventor: Chia-Po Chang, Changhua (TW)

(73) Assignee: HAIN YO ENTERPRISES CO., LTD., Changhua (TW)

(21) Appl. No.: 14/676,078

(22) Filed: Apr. 1, 2015

(51) Int. Cl. E03C 1/04; F16K 27/04; F16K 11/065

(52) U.S. Cl. CPC E03C 1/04; F16K 11/0655; F16K 27/04; E03C 2001/026

(57) ABSTRACT

A fine ceramic valve may include a valve body, a valve base and a sealing unit. The valve base is located under the valve body and has a top board. A drain hole is disposed on the top board, and a water inlet duct extends downwardly from each of the two sides of the drain hole, wherein each of the two water inlet ducts has two side walls connected with each other, an outer arc and an inner wall, and the bottom is closed, and the top portion of the top board corresponding to each of the two water inlet ducts has a water through hole to guide the water down into the water inlet duct. The sealing unit has a first ring with a vertical axial pore, and each of two sides of the first ring downwardly connects with a second ring with a horizontal axial pore.

### FIELD OF THE INVENTION

The present invention relates to a fine ceramic valve to control water flow, and more particularly to a fine ceramic valve to change the mixing ratio of hot and cold water and control the amount of water.

### BACK GROUND OF THE INVENTION

The current faucet (as shown in FIGS. 9 and 10) has a control valve (40) in the faucet body (30) to control the flow and change the mixing ratio of hot and cold water, and control the amount of water. The faucet body (30) includes a compartment (31) which is reserved during casting process, and vertical partitions (32) are located under the compartment. The purpose of the vertical partition (32) is to separate the inlets flowing into the faucet body (30) to a cold water inlet duct (33) and a hot water inlet duct (34), and each inlets has a water through hole (35) on the compartment to let water flow upward into the compartment (31). The two sides on the back of the faucet body (30) connect with the cold water inlet (36) and the hot water inlet (37) respectively to let hot and cold water flow into the faucet. The cold water inlet (36) is configured to connect to the cold water source through a cold water inlet duct (33), while the hot water inlet (34) is configured to connect to the hot water source through the hot water inlet duct (37). The restricting holes (311) are formed on the bottom of the compartment (31) for positioning pins of control valve (40). On the backside of the compartment (31) has an outlet hole (312) to connect with the drain pipe (38) of the faucet body (30). The control valve (40) has a cold water inlet and a hot water inlet corresponding to the water through hole (35) to let the cold water and the hot water flow into the control valve (40) respectively after being mixed in the control valve (40). The mixed water flow out of the faucet from the outlet hole of control valve (40) through the outlet hole (312) to the drain pipe (38) of the faucet body (30). The positioning pins extend from the bottom of control valve (40), and by engaging the positioning pins with the restricting holes (311) of the faucet body (30), the cold water inlet and hot water inlet on the control valve (40) are able to align more precisely to the water through holes (35) and outlet hole (312) on the faucet body (30).

However, conventional control valve is disadvantageous because: (i) the design of faucet body (30) is limited by the cold water inlet, the hot water inlet and the outlet hole, which are on the bottom of control valve (40), so that the vertical partitions and the water through holes are needed so the water can flow up through the water through holes (35) and then arrive the compartment (31) to separate the cold and the hot water. However, the installation of vertical partitions (32) in the faucet body (30) makes design of flow channels in the body become more complex, so that the faucet body (30) will be more difficult to make and the rate of manufacturing defect is increasing; and (ii) the cold water and the hot water would flow into the cold water inlet duct (33) and hot water inlet duct (34) first respectively, and then flow up through the water through holes (35) respectively to reach the control valve (40). This structure with multiple bendings would increase the noise when the water transports in the faucet, also the water is more difficult to flow in the faucet with such design. Therefore, there remains a need for a new and improved design for a faucet control valve to overcome the problems presented above.

### SUMMARY OF THE INVENTION

The present invention provides a fine ceramic valve, which is used with a faucet body. The fine ceramic valve comprises a valve body, a valve base and a sealing unit. In one embodiment, the valve body comprises a valve shell, which contains a valve stem and two valve discs. The valve stem is used to make two valve discs aligned or misaligned to control the switch or change the mixing ratio of cold water and hot water. The lower edge of valve shell has a connecting hole to secure the valve base. The valve base, having a top board, is located under the valve body. A drain hole is disposed on the top board, and a water inlet duct extends downwardly from each of the two sides of the drain hole. Each of the two water inlet ducts has two side walls connected with each other, an outer arc and an inner wall, and the bottom is closed. The top portion of the top board corresponding to each of the two water inlet ducts has a water through hole to guide the water down into the water inlet duct. Each of the water inlet ducts is connected to a cold/hot water inlet outwardly penetrating the outer arc, and a bottom portion of each water inlet ducts has at least one positioning pin extending therefrom. The sealing unit comprises a first ring with a vertical axial pore, and each of two sides of the first ring downwardly connects with a second ring with a horizontal axial pore. The first ring is mounted on a periphery of the top board of the valve base, so the second ring can be secured on the side edges and bottom of water inlet ducts. The faucet body is integrally molded and has a division chamber and a control valve chamber inside a central portion thereof, and the division chamber and the control valve chamber are connected with each other. The control valve chamber has an opening at a top portion thereof for penetration, and a bottom thereof connects with the division chamber by a ladder-shaped flange. Backside of the faucet body has a cold water inlet and a hot water inlet, which are connected with a cold water inlet duct and a hot water inlet duct on both sides of the faucet body, and the water is directed into the division chamber through a horizontal perforation. A water outlet is formed on a front edge of the division chamber to an outlet duct of the faucet body, so the cold water and the hot water are able to flow through the outlet duct individually or can be mixed in the outlet duct and then flow out of the water outlet. A bottom portion of the division chamber has restricting holes for the positioning pins of the fine ceramic valve to mount on the division chamber.

Comparing with conventional faucet control valves, the present invention is advantageous because: (i) by installing the inlet ducts combining with the cold/hot water inlets, , the fine ceramic valve of faucet can separate cold water and hot water in the faucet body without installing the vertical partitions to simplify the design of the internal flow channel, so that the faucet body can be more easily to manufacture and thus the yield can be significantly improved; and (ii) with the design of the cold/hot water inlets to penetrate laterally, the water can directly flow into the fine ceramic valve without passing through a segment with multiple bendings to effectively reduce noises, and make the cold water and the hot water flow more smoothly.

### BRIEF DESCRIPTION OF THE DRAWINGS

FIG. 1 is a three-dimensional, exploded view of the fine ceramic valve of the present invention.

FIG. 2 is a plain view of the fine ceramic valve of the present invention.

FIG. 3 is a sectional view along line A-A in FIG. 2 of the present invention.

FIG. 4 is a plain view from another angle of the fine ceramic valve in the present invention.

FIG. 5 is a sectional view along line B-B in FIG. 5 of the present invention.

FIG. 6 is a schematic view of disposing the fine ceramic valve in the faucet body of the present invention.

FIG. 7 is sectional view of the present invention used with a faucet.

FIG. 8 is another sectional view of the present invention used with a faucet.

FIG. 9 is a prior art.

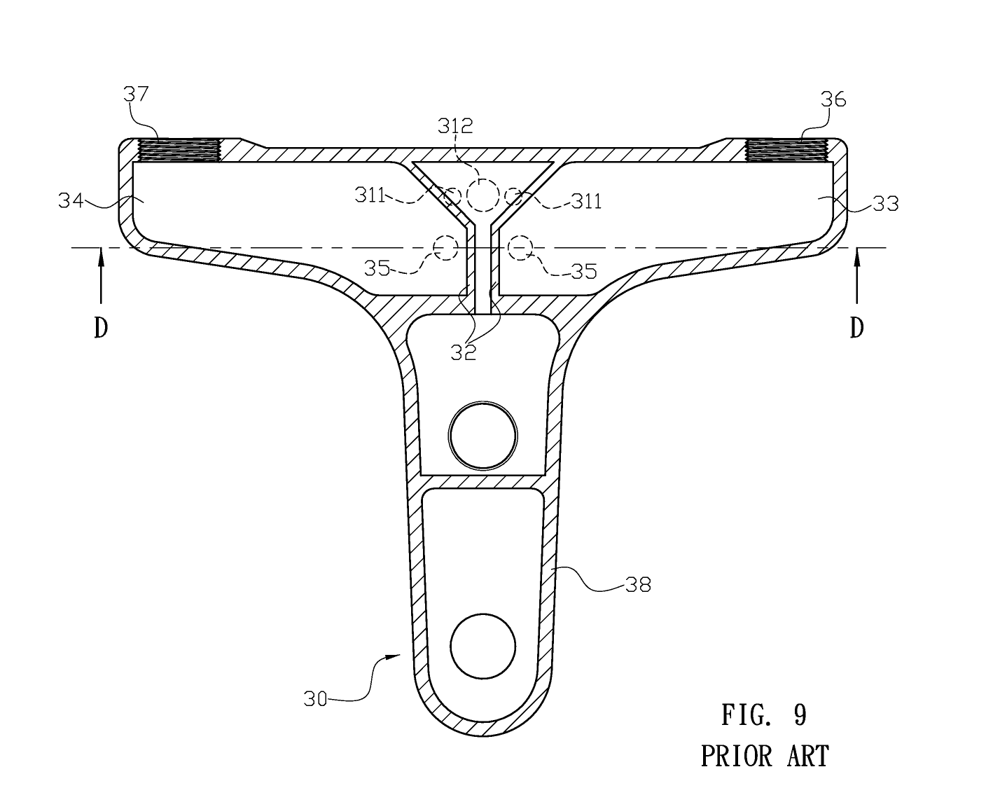

FIG. 10 is a prior art in use.

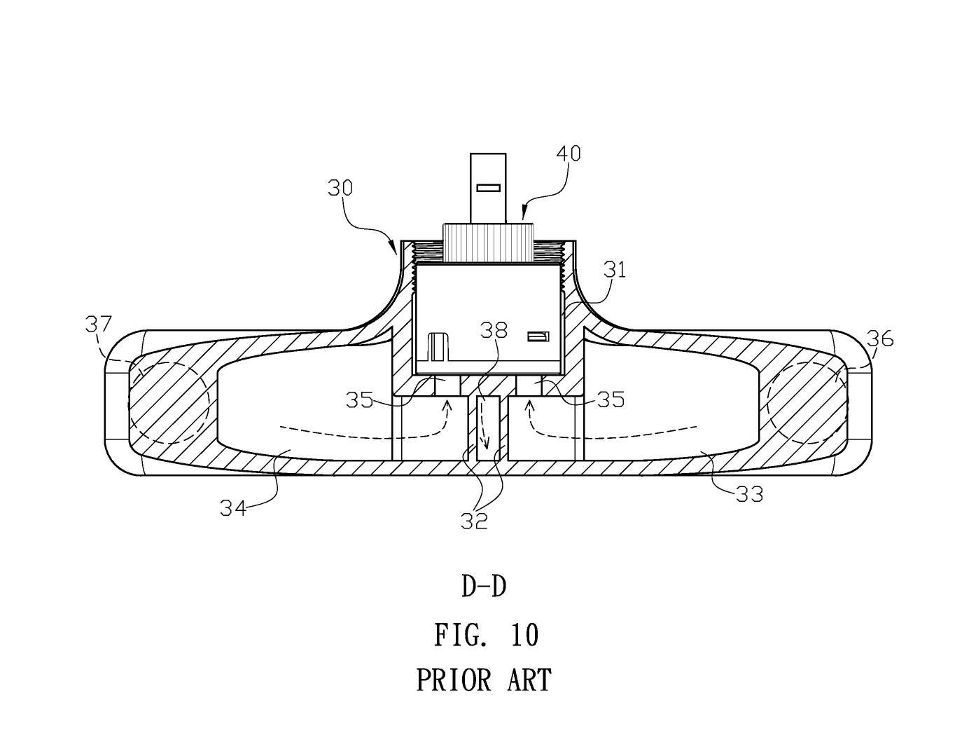

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

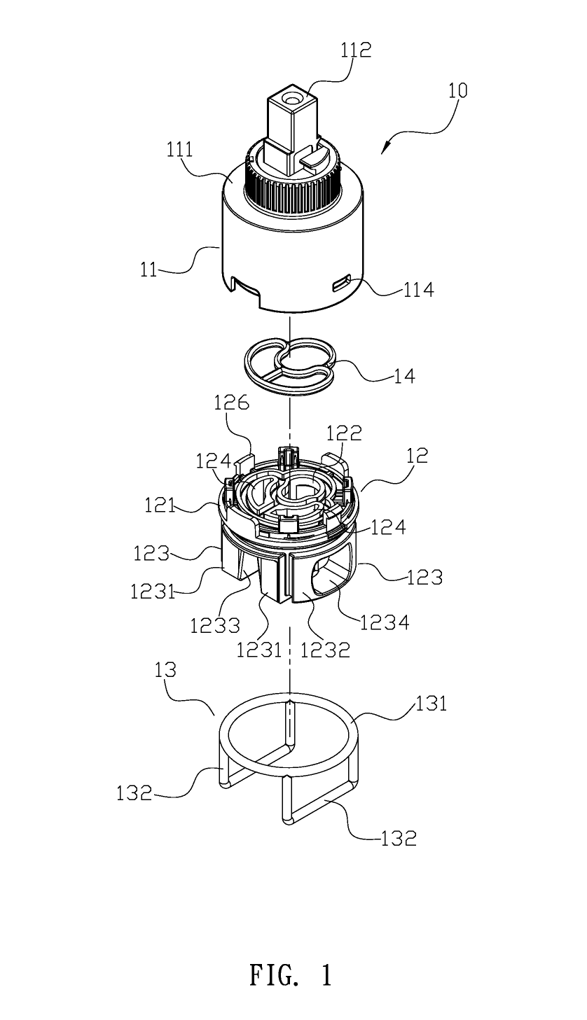

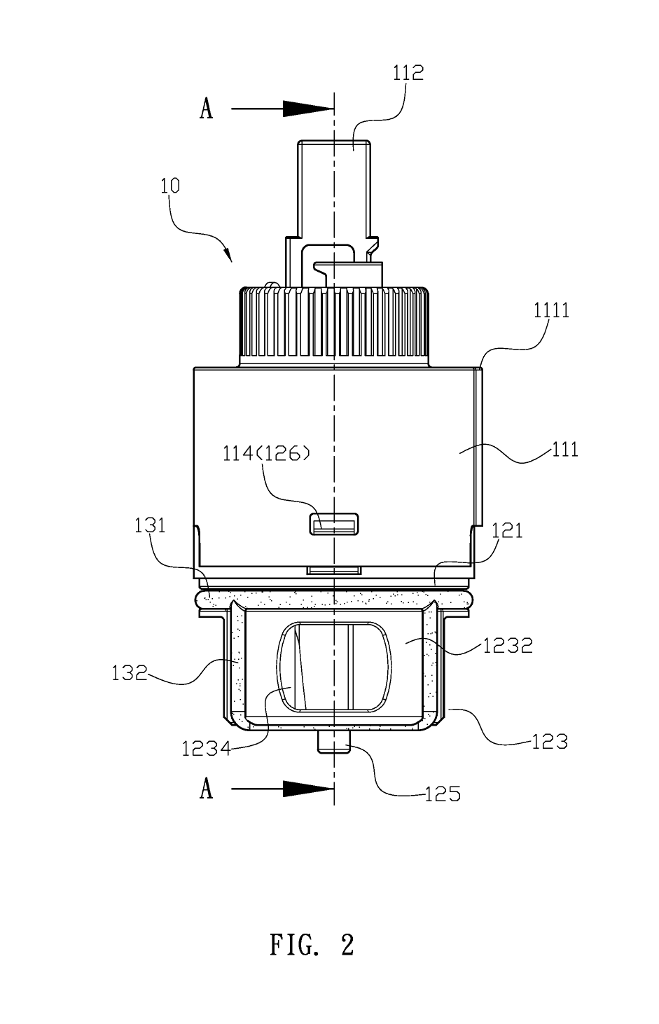

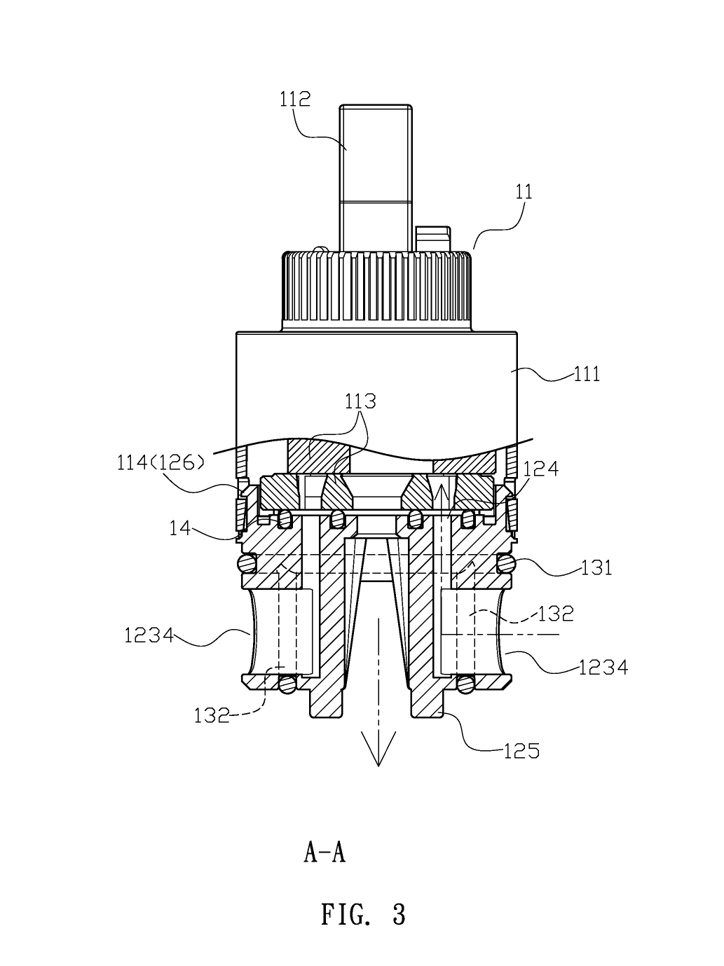

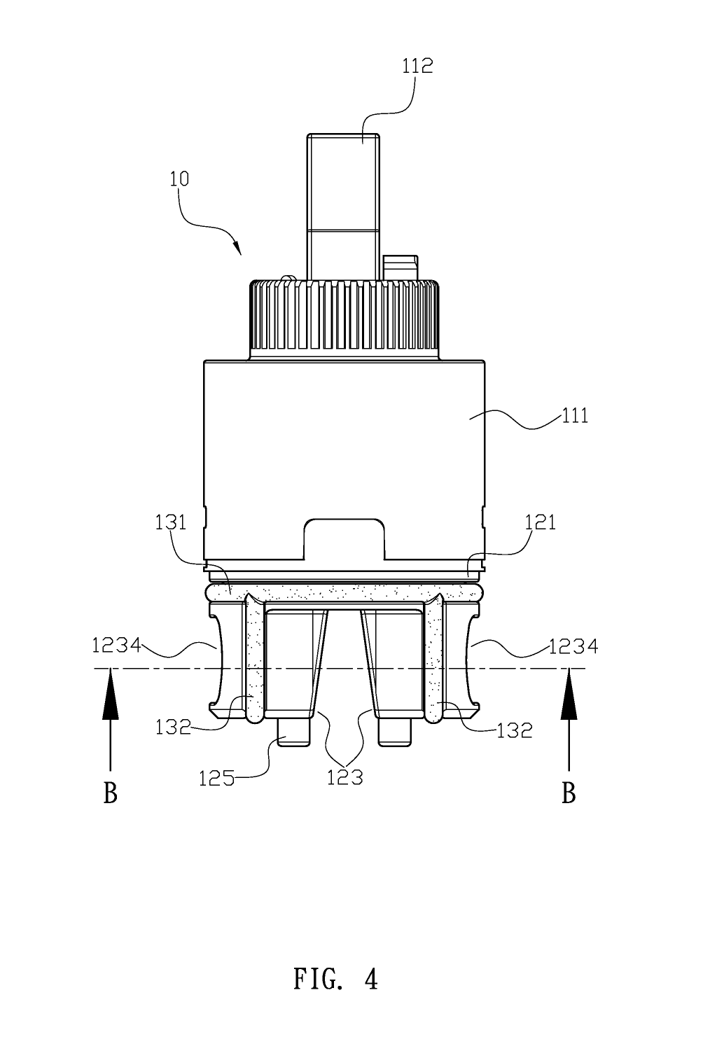

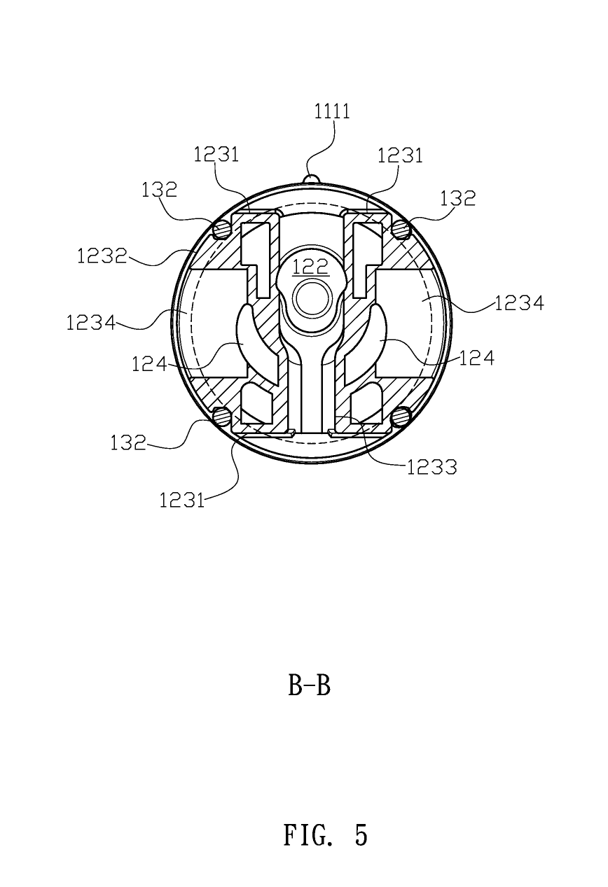

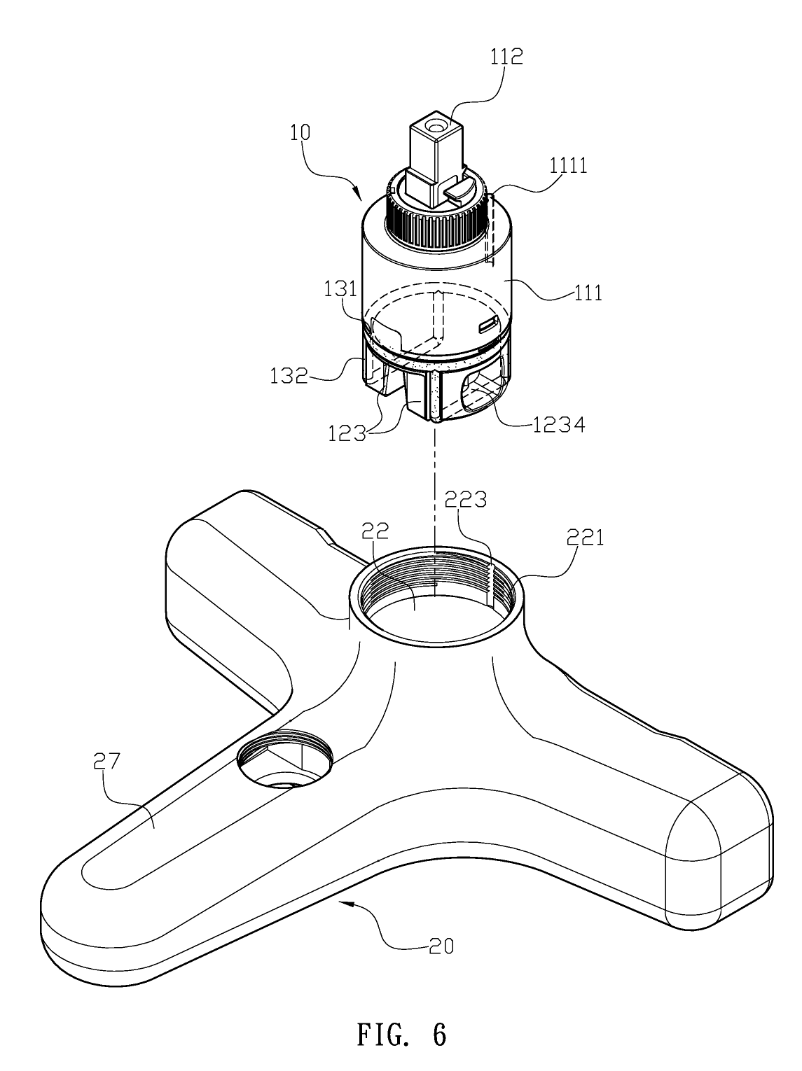

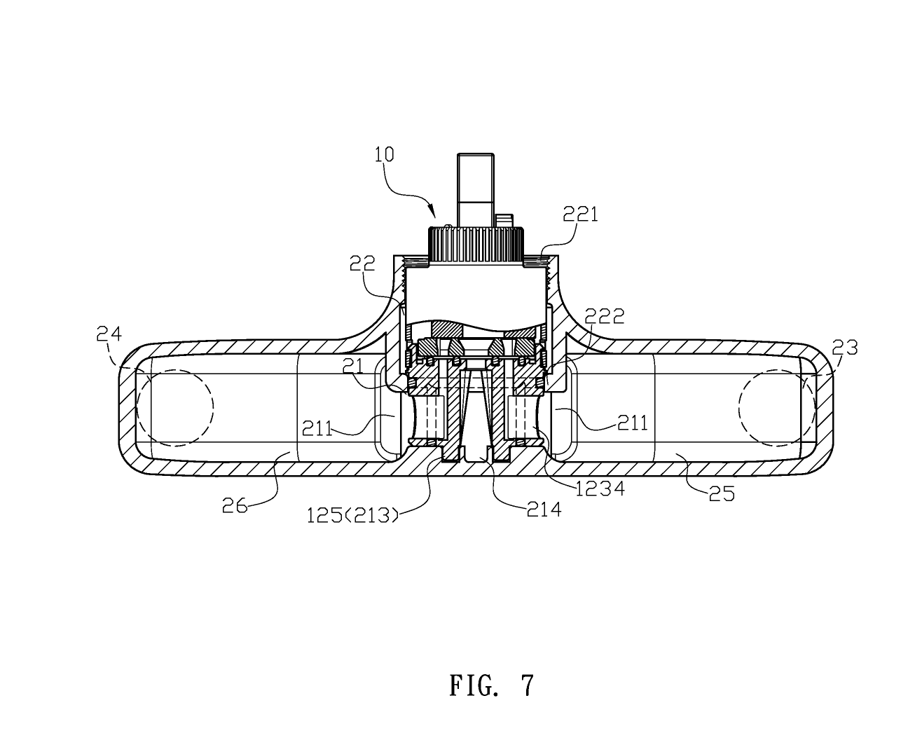

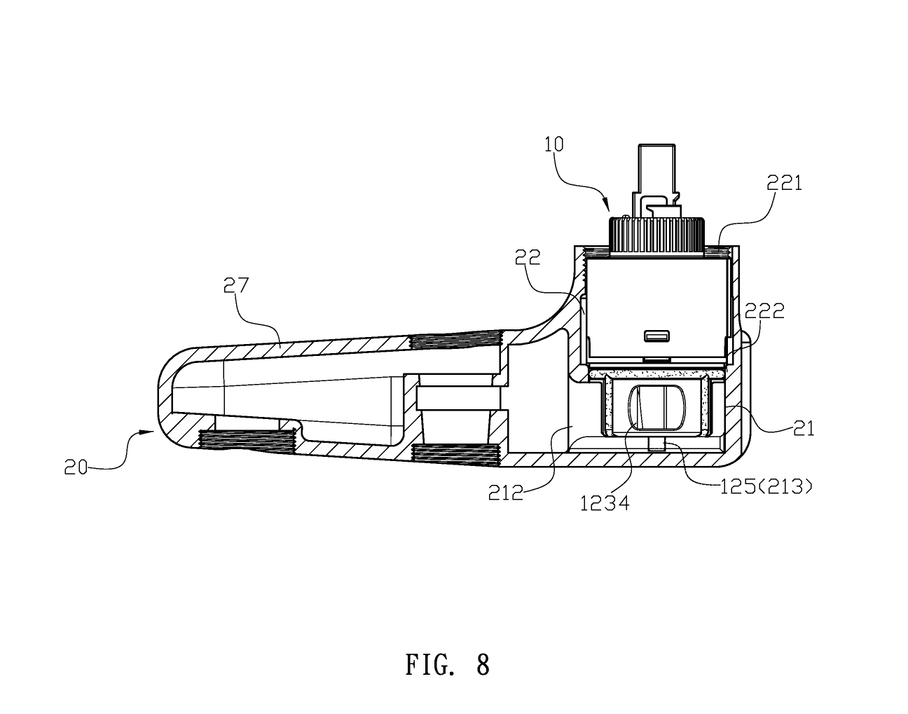

Referring to FIGS. 1 to 8, the present invention provides a structure of a fine ceramic valve for faucets. The fine ceramic valve (10) is used with a faucet body (20). The fine ceramic valve (10) comprises a valve body (11), a valve base (12) and a sealing unit (13). In one embodiment, the valve body (11) comprises a valve shell (111), which contains a valve stem (112) and two valve discs (113). The valve stem (112) is used to make two valve discs (113) aligned or misaligned to control the switch or change the mixing ratio of cold water and hot water. The lower edge of valve shell (111) has a connecting hole (114) to secure the valve base (12). The valve base (12), having a top board (121), is located under the valve body (11). A drain hole (122) is disposed on the top board (121), and a water inlet duct (123) extends downwardly from each of the two sides of the drain hole (122). Each of the two water inlet ducts (123) has two side walls (1231) connected with each other, an outer arc (1232) and an inner wall (1233), and the bottom is closed. The top portion of the top board (121) corresponding to each of the two water inlet ducts (123) has a water through hole (124) to guide the water down into the water inlet duct (123). Each of the water inlet ducts (123) is connected to a cold/hot water inlet (1234) outwardly penetrating the outer arc (1232), and a bottom portion of each water inlet ducts (123) has at least one positioning pin (125) extending therefrom. The sealing unit (13) comprises a first ring (131) with a vertical axial pore, and each of two sides of the first ring downwardly connects with a second ring (132) with a horizontal axial pore. The first ring is mounted on a periphery of the top board (121) of the valve base (12), so the second ring (132) can be secured on the side edges and bottom of water inlet ducts (123). The faucet body (20) is integrally molded and has a division chamber (21) and a control valve chamber (22) inside a central portion thereof, and the division chamber (21) and the control valve chamber (22) are connected with each other. The control valve chamber (22) has an opening (221) at a top portion thereof for penetration, and a bottom thereof connects with the division chamber (21) by a ladder-shaped flange (222). Backside of the faucet body (20) has a cold water inlet (23) and a hot water inlet (24), which are connected with a cold water inlet duct (25) and a hot water inlet duct (26) on both sides of the faucet body (20), and the water is directed into the division chamber (21) through a horizontal perforation (211). A water outlet (212) is formed on a front edge of the division chamber (21) to an outlet duct (27) of the faucet body (20), so the cold water and the hot water are able to flow through the outlet duct (27) individually or can be mixed in the outlet duct (27) and then flow out of the water outlet (212). A bottom portion of the division chamber (21) has restricting holes (213) for the positioning pins (125) of the fine ceramic valve (10) to mount on the division chamber (21).

In one embodiment, a clutch (126) extends from the top board (121), which is configured to engage with the connecting hole (114) of the valve body (11).

In another embodiment, a gasket (14) is secured on the top board (121) corresponding to the drain hole (122) and the water through hole (124).

In still another embodiment, a threaded segment is formed at an opening (221) of the control valve chamber (22) to engage with a locking ring so the fine ceramic valve (10) can be insulated in the control valve chamber (22). By mounting the sealing unit (13) between the top board (121) and ladder-shaped flange (222), and between the water inlet duct (123) and the inner wall and the bottom of the division chamber (21), the fine ceramic valve (10) can successful prevent leakage when the faucet is in use.

In a further embodiment, a recessed portion (214) is formed at a bottom portion of the division chamber (21) along the direction of the outlet duct (27), which is used to increase the output water volume of the faucet body (20).

In still a further embodiment, a periphery of the valve shell (111) has a protruding block (1111) to engage with a corresponding recessed groove (223) at an inner wall of the control valve chamber (22).

In actual application, the supply of the cold water and the hot water is respectively from the cold water inlet (23) and the hot water inlet (24), and flows into the cold water inlet duct (25) and hot water inlet duct (26) respectively. With horizontal perforations (211), the cold water and the hot water are sent directly from the cold/hot water inlets (1234) into the fine ceramic valve (10). Also, with the valve stem (112) of control valve (10), the cold water and the hot water, which flow from the water inlet ducts (123) through the water through holes (124) to the valve body (11), can be used individually or be mixed before the water flow out of the water outlet (212). By connecting the water outlet (212) to the flow duct, which is the interval between the two water inlet ducts (123), the water can flow through the flow duct to the drain hole (122) and flow out of the outlet duct (27).

Comparing with conventional faucet control valves, the present invention is advantageous because: (i) by installing the inlet ducts (123) combining with the cold/hot water inlets (1234), the fine ceramic valve of faucet can separate cold water and hot water in the faucet body (20) without installing the vertical partitions to simplify the design of the internal flow channel, so that the faucet body (20) can be more easily to manufacture and thus the yield can be significantly improved; and (ii) with the design of the cold/hot water inlets (1234) to penetrate laterally, the water can directly flow into the fine ceramic valve (10) without passing through a segment with multiple bendings to effectively reduce noises, and make the cold water and the hot water flow more smoothly.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A fine ceramic valve, which is adapted to use with a faucet, comprising:
a valve body having a valve shell, which includes a valve stem and two valve discs, the valve stem used to make two valve discs aligned or misaligned to control the switch or change the mixing ratio of cold water and hot water;
a valve base located under the valve body and having a top board, a drain hole disposed on the top board, and a water inlet duct extending downwardly from each of the two sides of the drain hole, wherein each of the two water inlet ducts has two side walls connected with each other, an outer arc and an inner wall, and the bottom is closed, and the top portion of the top board corresponding to each of the two water inlet ducts has a water through hole to guide the water down into the water inlet duct; and
a sealing unit having a first ring with a vertical axial pore, and each of two sides of the first ring downwardly connecting with a second ring with a horizontal axial pore, wherein the first ring is mounted on a periphery of the top board of the valve base, so the second ring is secured on the side edges and bottom of water inlet ducts.

2. The fine ceramic valve of claim 1, wherein a clutch extends from the top board, which is configured to engage with a connecting hole of valve body.

3. The fine ceramic valve of claim 1, wherein a gasket is secured on the top board corresponding to the drain hole and the water through hole.

4. The fine ceramic valve of claim 1, wherein a periphery of the valve shell has a protruding block to engage with a corresponding recessed groove.

5. The fine ceramic valve of claim 1, wherein a bottom portion of each water inlet ducts has at least one positioning pin extending therefrom.
